(19) United States
(12) Patent Application Publication
(10) Pub. No.: US 2025/0265452 A1
(43) Pub. Date: Aug. 21, 2025

(54) METHOD AND DEVICE FOR COMPRESSING A NEURAL NETWORK

(71) Applicants: UNIVERSITE CLAUDE BERNARD LYON 1 (UCBL), VILLEURBANNE (FR); CENTRE NATIONAL DE LA RECHERCHE SCIENTIFIQUE, PARIS (FR); INSTITUT NATIONAL DES SCIENCES APPLIQUEES DE LYON (INSA LYON), VILLEURBANNE (FR); ECOLE CENTRALE DE LYON, ECULLY (FR); POLITECNICO DI TORINO, TURIN (FR)

(72) Inventors: Alberto BOSIO, Chazay d’Azergues (FR); Annachiara RUOSPO, Turin (IT); Edgar Ernesto SANCHEZ SANCHEZ, Turin (IT)

(21) Appl. No.: 18/583,312

(22) Filed: Feb. 21, 2024

(51) Int. Cl. G06N 3/0495; G06N 3/082

(52) U.S. Cl. CPC G06N 3/0495; G06N 3/082

(57) ABSTRACT

The invention concerns a computer-implemented method for compressing a neural network comprising neurons and synapses interconnecting the neurons, the method being implemented by a compressing device and comprising: determining, for each synapse of a plurality of synapses of the neural network, a capacity representative of a level of influence of a synaptic weight assigned to the synapse, the capacity being determined as a function of the synaptic weight and as a function of data exchanged through the synapse; and pruning one or more synapses of the plurality of synapses, as a function of the determined capacity of each of the one or more synapses.

### FIELD

The present invention generally relates to the general field of automatic data processing. It relates more specifically to a method for compressing a neural network. The invention also concerns a compressing device configured to perform said compression method.

### BACKGROUND

Nowadays, most of the electronic devices deployed in safety-critical applications execute applications leveraging Artificial Intelligence, which are mainly based on artificial neural networks.

Artificial Neural networks are deep learning models that employ one or more layers of neurons to generate an output for a received input. In more detail, a neural network is a collection of nodes, also named “artificial neurons” connected with each other's through “synapses”. Similar to the synapses in a biological brain, synapses of a neural network can transmit a signal to other neurons. This synapse linking two or more neurons is regulated by the strength of the signal between these neurons, which is typically modelled with a constant parameter, also called “synaptic weight”. In feedforward neural networks, binding the strength of a signal to a synaptic weight alone is reasonable, because there is only one synaptic weight associated with one synapse. Typically, neurons are aggregated into layers. Different layers may perform different transformations on their inputs. Some neural networks include one or more non-terminal layers, named “hidden layers”, in addition to the output layer. The output of each hidden layer is used as input to the next layer in the network, i.e., the next hidden layer or the output layer of the network. Each layer of the network generates an output from a received input in accordance with current values of a respective set of parameters.

Convolutional Neural Networks, CNNs, are a type of feed-forward neural network that is sometimes considered as the most widely used predictive model in the field of Artificial Intelligence. CNNs are particularly well suited to perform specific tasks, such as image and video recognition, image classification, image segmentation, medical image analysis and/or natural language processing.

However, one important limitation about the adoption of newer versions of neural networks is the quantity of memory required for storing their parameters (e.g., the “synaptic weights” assigned to the synapses). As a matter of fact, the latest versions of neural networks can require from megabits to gigabits of memory for storing their parameters. As an example, in the natural language processing domain, modern neural networks can reach to handle trillions of parameters, which thus requires a huge amount of computational and memory resources for training, but also for operating the neural network in real time.

As a consequence, it may then be desirable to reduce the size of neural networks, while preserving accuracy and performance.

### SUMMARY

The purpose of the present invention is to overcome all or some of the limitations of the prior art solutions, particularly those outlined here above, by compressing a neural network, and more precisely by pruning synapses of the neural network assigned with weights whose magnitude is close to zero, while without the pruning resulting in a significant reduction of its accuracy and resiliency.

To this end, the present invention first provides a computer-implemented method for compressing a neural network comprising neurons and synapses interconnecting the neurons, the method being implemented by a compressing device and comprising:
determining, for each synapse of a plurality of synapses of the neural network, a capacity representative of a level of influence of a synaptic weight assigned to the synapse, the capacity being determined as a function of the synaptic weight and as a function of data exchanged through the synapse; and
pruning one or more synapses of the plurality of synapses, as a function of the determined capacity of each of the one or more synapses.

The compression method of the invention aims at reducing the number of parameters (or weights) of a neural network. Given a neural network f(X,W), where X is the input and W is the set of parameters (or weights), the compression method then seeks a subset W′ such that the remaining parameters of W are pruned (e.g., removed) while making sure that the accuracy of the neural network is not impacted.

The compression method of the invention improves the accuracy of the neural network in comparison with traditional pruning methods of the state of the art. By “improving the accuracy of the neural network”, reference is made here to obtaining results that are more accurate than if the neural network is not compressed according to the invention.

In its general principle, the compression method according to the invention provides a novel procedure for compressing a neural network by pruning synapses of the neural network assigned with synaptic weights whose magnitude is close to a threshold, but also by considering the dynamic aspect of the information flowing through synapses.

In further details, after the training phase of the neural network, synaptic weights own all the information captured from a training dataset D. Trained synaptic weights are “static” and correspond to constant data (e.g., read-only variables) that keep the same value during the inference phase. On the other hand, the information flowing through synapses is “dynamic” since it depends on the synaptic weight and the data exchanged through the synapse they are assigned to. Taking into account the dynamic aspect of the synapses allows a certain accuracy to be ensured, and a fortiori this insure the reliability of that compressed neural network.

In some implementations, the one or more pruned synapses have a determined capacity lower than or equal to a first threshold.

In some implementations, pruning one or more synapses comprises removing the one or more synapses from the neural network, and/or setting the synaptic weights assigned to the one or more synapses to zero, and/or removing the synaptic weight assigned to the one or more synapses from a set of parameters of the neural network.

In some implementations, the capacity Cₛ_{ⱼ} of a synapse sⱼ is determined as a function of

$$\vert {w}_{k} \vert * {log}_{2} ( 1 + \frac{{i}_{j}}{\frac{\partial L}{\partial {w}_{k}}} )$$

where

$$\frac{\partial L}{\partial {w}_{k}}$$

is the partial derivative of a loss L with respect to a synaptic weight wₖ, and iⱼ is a parameter representative of the data exchanged through the synapse.

In some implementations, a comparable synaptic weight is assigned to a plurality of synapses, and the method further comprises determining a criticality of the comparable synaptic weight as a function of the determined capacities of the plurality of synapses assigned with a comparable synaptic weight;
and the pruning comprises pruning the plurality of synapses assigned with the comparable synaptic weight, if the determined criticality is than or equal to a second threshold.

According to the invention, synaptic weights are said to be “comparable” when their values are the same, or when their values belong to a predetermined interval.

In some implementations, the criticality of the comparable synaptic weight is determined by adding the capacities of the synapses of the plurality assigned with a comparable synaptic weight.

In some implementations, the synapses of the plurality of synapses are assigned with a comparable synaptic weight if the synapses are assigned with a same synaptic weight or if the synapses are assigned with a synaptic weight belonging to a predetermined range.

In some implementations, the criticality C_{w}_{ₖ} of the comparable synaptic weight wₖ is determined as a function of

$${\sum }_{j = 0}^{J - 1} ( \vert {w}_{k} \vert * {log}_{2} ( 1 + \frac{{i}_{j}}{\frac{\partial L}{\partial {w}_{k}}} ) )$$

with wₖ the synaptic weight,

$$\frac{\partial L}{\partial {w}_{k}}$$

the partial derivative of a loss L with respect to the synaptic weight wₖ, iⱼ a parameter representative of the data exchanged through a synapse j∈[0,J−1], and J the number of synapses assigned with a comparable synaptic weight.

In some implementations, the neural network is an over-parameterized convolutional neural network.

According to a second aspect, the present invention concerns a compressing device including: at least one processor; and at least one non-transitory computer readable medium comprising instructions stored thereon which when executed by the at least one processor configure the compressing device to:
determine, for each synapse of a plurality of synapses of the neural network, a capacity representative of a level of influence of a synaptic weight assigned to the synapse, the capacity being determined as a function of the synaptic weight and as a function of data exchanged through the synapse; and
prune one or more synapses of the plurality of synapses, as a function of the determined capacity of each of the one or more synapses.

Embodiments of the present invention also extend to programs which, when run on a computer or processor, cause the computer or processor to carry out the method described above or which, when loaded into a programmable device, cause that device to become the device described above. The program may be provided by itself, or carried by a carrier medium. The carrier medium may be a storage or recording medium, or it may be a transmission medium such as a signal. A program embodying the present invention may be transitory or non-transitory.

### BRIEF DESCRIPTION OF THE DRAWINGS

FIG. 1 illustrates a particular implementation of a compressing device according to the invention;

FIG. 2 illustrates an example of the hardware architecture of the compressing device for the implementation of the compression method illustrated by FIGS. 3 and 4;

FIG. 3 is a flowchart of a compression method executed by a compressing device according to a first embodiment of the invention;

FIG. 4 is a flowchart of a compression method executed by a compressing device according to a second embodiment of the invention;

FIG. 5 is an experimentation result illustrating the evolution of the accuracy of a ResNet-20 CNN trained and tested on FMNIST, as a function of a number of removed weights;

FIG. 6 is an experimentation result illustrating the evolution of the accuracy of a ResNet-20 CNN trained and tested on CIFAR10, as a function of a number of removed weights;

FIG. 7 is an experimentation result illustrating the evolution of the accuracy of a ResNet-32 CNN trained and tested on CIFAR10, as a function of a number of removed weights;

FIG. 8 is an experimentation result illustrating the evolution of the accuracy of a ResNet-20 CNN trained and tested on FMNIST, as a function of sparsity;

FIG. 9 is an experimentation result illustrating the evolution of the accuracy of a ResNet-20 CNN trained and tested on CIFAR10, as a function of sparsity;

FIG. 10 is an experimentation result illustrating the evolution of the accuracy of a ResNet-32 CNN trained and tested on CIFAR10, as a function of sparsity;

FIG. 11 is an experimentation result illustrating the probability density function of a ResNet-20 CNN trained and tested on FMNIST;

FIG. 12 is an experimentation result illustrating the probability density function of a ResNet-20 CNN trained and tested on CIFAR10; and

FIG. 13 is an experimentation result illustrating the probability density function of a ResNet-32 CNN trained and tested on CIFAR10.

### DETAILED DESCRIPTION

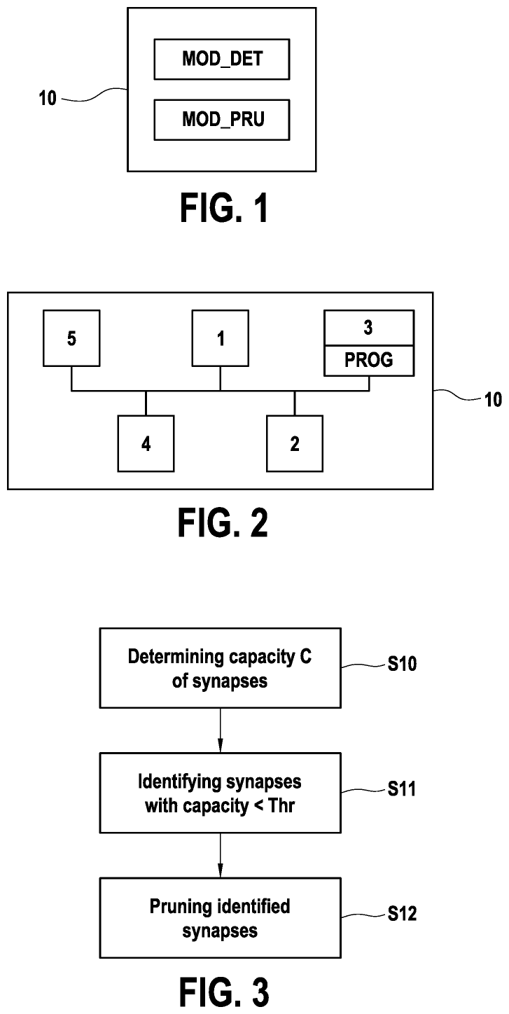

FIG. 1 illustrates a particular implementation of a compressing device according to the invention. As illustrated by FIG. 1, the compressing device 10 comprises a module MOD_DET for determining a capacity representative of a level of influence of a synaptic weight assigned to a synapse and a module MOD_PRU for pruning one or more synapses of a neural network. The functionalities attached to each of the modules are explained in detail later on when describing modes of implementation of said compression method.

The rest of the description is aimed more specifically at a compression method of a trained neural network. The invention remains applicable whatever the nature of the neural network considered (convolutional, perceptron, auto-encoder, recurrent, etc.), in particular for any deep neural network.

In particular implementations, the neural network is an over-parameterized convolutional neural network. An over-parameterized neural network refers to the scenario where the number of parameters of the neural network is higher respect to the minimal number required to execute the same task. Due to its over-parameterized nature, such a neural network has the capacity to overfit any set of labels including pure noise. An over-parameterized convolutional neural network typically has a low (e.g., near-zero) training error.

In addition, no limitation is attached to the kind of data that may be processed by the neural network. In the same way, no limitation is attached to the way the compressed neural network is used.

In particular implementations, this compressed neural network may be used for image and video recognition, image classification, image segmentation, medical image analysis and/or natural language processing.

In particular implementations, this compressed neural network may be part of or may correspond to a neural network-based classifier for classifying data. In particular implementations, the neural network-based classifier includes a backbone network configured for feature detection or classification from input samples, and another part of the neural network-based classifier is used to automatically classify the input samples based on the learned representations.

In the case where the compressed neural network is used for classification, no limitation is attached to the classification that may be output based on the input (i.e., the nature of the classes is not a limiting factor of the invention). For example, if the input samples of the classification model are images or features that have been extracted from images, the output generated by the classification model for a given image may be an estimate of the probability that the image contains an image of an object belonging to given classes. Specifically, these may include, for example, images of road traffic taken by an autonomous vehicle or by a road-side unit, so that it can be determined whether vehicles in the image are at risk of collision.

According to another example, if the inputs of the classification model are Internet resources (e.g., web pages), documents, or portions of documents or features extracted from Internet resources, the output generated by the classification model for a given Internet resource, document, or portion of a document may be a score for each of a set of topics, with each score thus representing an estimate of the probability that the Internet resource, document, or document portion is about the topic.

According to another example, if the inputs of the classification model are features of an impression context for a particular advertisement, the output generated by the classification model may be a score that represents an estimate of the probability that the particular advertisement will be clicked on.

According to another example, if the inputs of the classification model are features of a personalized recommendation for a user, e.g., features characterizing the context for the recommendation, e.g., features characterizing previous actions taken by the user, the output generated by the classification model may be a score for each of a set of content items, with each score representing an estimate of the probability that the user will respond favourably to being recommended the content item.

According to another example, if the input of the classification model is text in one language, the output generated by the classifier may be a score for each of a set of pieces of text in another language, with each score representing an estimate of the probability that the piece of text in the other language is a proper translation of the input text into the original language.

According to another example, if the input of the classification model is a spoken utterance, a sequence of spoken utterances, or features derived from one of the two, the output generated by the classification model may be a score for each of a set of pieces of text, each score representing an estimate of the probability that the piece of text is the correct transcript for the utterance or sequence of utterances.

Examples of typical technical applications of a classification may include, without limitation: classification of digital images (e.g. in health care, for example cardiac monitoring in order to detect irregular beats of a patient), video and audio or voice signals based on low-level characteristics (e.g. contours or pixel attributes for images).

It is worth noting that in a general way, the invention can find an application in any industrial and technical field where neural networks are used. The classification task is only a non-limitative example of use of a neural network compressed according to the invention.

FIG. 2 illustrates an example of the hardware architecture of the compressing device 10 for the implementation of the compression method according to the invention.

To this end, the compressing device 10 has the hardware architecture of a computer. As shown in FIG. 2, the compressing device 10 comprises a processor 1. Although illustrated as a single processor 1, two or more processors can be used according to particular needs, desires, or particular implementations of the compressing device 10. Generally, the processor 1 executes instructions and manipulates data to perform the operations of the compressing device 10 and any algorithms, methods, functions, processes, flows, and procedures as described in the present disclosure.

The compressing device 10 also comprises communication means 5. Although illustrated as a single communication means 5 in FIG. 2, two or more communication means can be used according to particular needs, desires, or particular implementations of the compressing device 10. The communication means are used by the compressing device 10 for communicating with another computing system that is communicatively linked to that compressing device in a distributed environment. The other computing system may need to communicate with the compressing device of the invention, for example for a classification purpose.

Generally, the communication means 5 are operable to communicate with a telecommunication network and comprise logic encoded in software, hardware, or a combination of software and hardware. More specifically, the communication means 5 can comprise software supporting one or more communication protocols associated with communications such that the network or interface's hardware is operable to communicate physical signals within and outside of the illustrated compressing device 10.

The compressing device 10 also comprises a random-access memory 2, a read-only memory 3, and a non-volatile memory 4. The read-only memory 3 of the compressing device 10 constitutes a recording medium conforming to the invention, which is readable by processor 1 and on which is recorded a computer program PROG conforming to the invention, containing instructions for carrying out the steps of the compression method according to the invention.

The program PROG defines functional modules of the compressing device 10, which are based on or control the aforementioned elements 1 to 5 of the compressing device 10, and which comprise in particular
a module MOD_DET for determining, for each synapse of a plurality of synapses of a neural network, a capacity representative of a level of influence of a synaptic weight assigned to the synapse, the capacity being determined as a function of the synaptic weight and as a function of data exchanged through the synapse; and
a module MOD_PRU for pruning one or more synapses of the plurality of synapses, as a function of the determined capacity of each of the one or more synapses.

The functionalities attached to each of the modules are explained in detail later on when describing modes of implementation of said compression method.

FIG. 3 is a flowchart of a compression method of a neural network executed by a compressing device 10 according to a first embodiment of the invention.

As already mentioned, this compression method aims at reducing the number of parameters (or weights) of a neural network. Given a neural network f(X,W), where X is the input and W is the set of parameters (or weights), the compression method seeks a subset W′ such that the remaining parameters of W are pruned (or set to 0), while making sure that the accuracy of the neural network is not impacted.

As shown in FIG. 3, the compression method comprises a first step S10 of determining a capacity Cₛ_{ⱼ}; of synapses of a neural network which is previously trained. This determining step S10 may be performed by the module MOD_DET previously mentioned.

In particular implementations, the step S10 of determining a capacity C comprises a sub-step of obtaining a non-compressed but trained neural network. In particular implementations, this step of obtaining the neural network includes receiving this neural network previously trained by another electronic device, using the communication means 5. This step S10 of determining a capacity Cₛ_{ⱼ} also comprises a sub-step of selecting at least a subset of—but possibly all—synapses of the obtained neural network.

This step S10 then comprises a sub-step of computing, for each of the selected synapses, a capacity representative of a level of influence of a synaptic weight assigned to the synapse. As further detailed below, that capacity is determined as a function of the synaptic weight assigned to the given synapse for which the capacity is computed, and as a function of data exchanged through the synapse. Thus, that capacity embodies both the static and dynamic nature of weights.

In particular implementations, the capacity Cₛ_{ⱼ} is computed as follows:

$${C}_{{s}_{j}} = \vert {w}_{k} \vert * {log}_{2} ( 1 + \frac{{i}_{j}}{\frac{\partial L}{\partial {w}_{k}}} )$$

where sⱼ is a synapse connecting two artificial neurons (neuₐ and neu_{b}); wₖ corresponds to the weight assigned to the synapse sⱼ,

$$\frac{\partial L}{\partial {w}_{k}}$$

is the partial derivative (also known as “gradient”) of the loss L with respect to the weight, and iⱼ is the average information flowing thought the synapse sⱼ.

In particular implementations, the average information iⱼ is computed by averaging the values at the input of the synapse sⱼ by running the inferences of the training dataset.

In particular implementations, the loss L named “torch.nn.CrossEntropyLoss” provided by PyTorch, a machine learning framework based on the Torch library is considered.

It is worth noting that this capacity is correlated with the Shannon-Hartley theorem. For the records, in information theory, the Shannon-Hartley theorem defines the maximum rate at which information can be transmitted over a communications channel of a specified bandwidth in the presence of noise. The invention is then based on the assumption that a synapse of an artificial neural network acts similarly to a noisy communications channel.

The compressing method also comprises a step S11 of identifying one or more synapses of the selected synapses with a capacity inferior to a predetermined threshold.

Finally, the compressing method comprises a step S12 of pruning the one or more synapses identified at step S11. This pruning step S12 may be performed by the module MOD_PRU previously mentioned. In particular implementations, the pruning comprises removing the one or more identified synapses from the neural network. In a variant, the pruning comprises setting the synaptic weights assigned to the one or more identified synapses to a predetermined threshold (e.g., zero). In a variant, the pruning comprises removing the synaptic weight assigned to the one or more synapses from a set of parameters of the neural network.

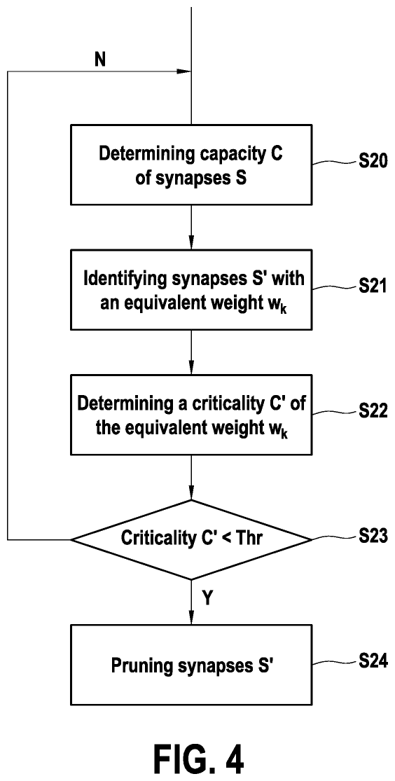

FIG. 4 is a flowchart of a compression method executed by a compressing device according to a second embodiment of the invention.

For the records, convolutional neural networks, CNNs, represent a class of artificial neural networks widely used in tasks like image classifications, image segmentation, object detections, natural language processing, and many others. CNNs are inspired by biological processes, and individual cortical neurons react to stimuli only in a restricted region of the visual field known as the “receptive field”. In a convolutional layer of a CNN, many synapses j∈[0,J−1] typically share the same synaptic weight wₖ. The aim of compression method according to that second embodiment of the invention is to consider the influence, and consequently the criticality, of a same synaptic weight wₖ. To that end, the contributions of all the synapses which share that same synaptic weight wₖ are considered.

As shown on FIG. 4, the compression method comprises a first step S20 of determining a capacity Cₛ_{ⱼ} of synapses of a neural network previously trained. This determining step S20 is similar to step S10, and is not re-described, for the sake of conciseness. This step S20 may be performed by the module MOD_DET previously mentioned.

The compression method also comprises a step S21 of identifying synapses s′ⱼ that are all assigned with a same synaptic weight wₖ.

If several synapses s′ⱼ are identified, a step S22 is implemented in which a criticality value C_{w}_{ₖ}′ of that synaptic weight wₖ is computed. In a variant, that step S22 is implemented if the number of identified synapses s′ⱼ is superior to a predetermined threshold.

In particular implementations, the criticality of the synaptic weight C_{w}_{ₖ}′ is computed by adding the contribution of all capacities Cₛ_{ⱼ}; of the corresponding synapses sⱼ where j∈[0,J−1]. In that case, the criticality may be expressed as follows:

$${C}_{{w}_{k}} = {\sum }_{j = 0}^{J - 1} {C}_{{s}_{j}} = {\sum }_{j = 0}^{J - 1} ( \vert {w}_{k} \vert * {log}_{2} ( 1 + \frac{{i}_{j}}{\frac{\partial L}{\partial {w}_{k}}} ) )$$

with wₖ the synaptic weight,

$$\frac{\partial L}{\partial {w}_{k}}$$

the partial derivative of a loss L with respect to the synaptic weight wₖ, iⱼ a parameter representative of the data exchanged through a synapse j∈[0,J−1], and J the number of synapses assigned with a comparable synaptic weight.

In the following, this criticality value is also named “Shannon-Hartley Criticality”, SHC, because of its correlation with the Shannon-Hartley theorem.

The compression method illustrated by that FIG. 4 then comprises a step S23 in which it is determined if the Shannon-Hartley Criticality is inferior or equal to a predetermined threshold. If so (“Y” branch), a step S24 is implemented during which the J synapses sⱼ are pruned. Otherwise, in an example, the compression method loops to step S20 (“N” branch).

Finally, and as just mentioned, the compression method comprises the step S24 of pruning the J synapses sⱼ. This pruning step S24 may be performed by the module MOD_PRU previously mentioned. In particular implementations, the pruning comprises removing the synapses sⱼ from the neural network. In a variant, the pruning comprises setting the synaptic weights assigned to the synapses sⱼ to a predetermined threshold (e.g., zero). In a variant, the pruning comprises removing the synaptic weight assigned to the synapses sⱼ from a set of parameters of the neural network.

### Experimental Results

The experimental results are gathered on some very representative state-of-the-art CNNs on image classification tasks, the ResNet architectures. Three different models have been trained and tested on two different open datasets, i.e., FMNIST and CIFAR10, always reaching an accuracy greater than 90%.

Table 1 reports details on the three convolutional neural network architectures used.

TABLE 1

| | | | Static | | |
|---|---|---|---|---|---|
| | | Accuracy | Parameters | Invention | |
| CNN model | Dataset | [%] | (weights) | Nodes | Edges |
| ResNet-20 | FMNIST | 94.86 | 271,391 | 414,794 | 37,166,272 |
| ResNet-20 | CIFAR10 | 91.67 | 272,474 | 416,842 | 37,449,024 |
| ResNet-32 | CIFAR10 | 93.09 | 465,665 | 646,218 | 63,208,768 |

The experimental results show advantages in two different directions. The first one concerns reliability. The proposed Shannon-Hartley Criticality, SHC, of a weight enables the identification of the most critical weights of a CNN. Experimental results show that by removing a very small quantity of weights having the highest SHC, the accuracy of the convolutional neural network drops from its golden value to a value below 10%, thus resulting in a random classifier.

The second one concerns the model compression and optimization. The proposed Shannon-Hartley Criticality, SHC, of a weight identifies the critical weights of a CNN. In this way, the weights having the lowest SHC values can be safely removed from the parameters of the neural network, while keeping the accuracy of the CNN at very high values near to its golden value. Compared to existing techniques, it is possible to remove a greater quantity of weights, while maintaining the original accuracy. This clearly brings advantages in the size of the model (by lowering the memory footprint), and consequently the energy efficiency of the model (by reducing the MAC operations of the CNN).

### First Direction: Effects of the SHC on the Reliability

Assigning the SHC to each weight allows the ordering of the weights according to their criticality: a high SHC value corresponds to a high criticality, and vice versa.

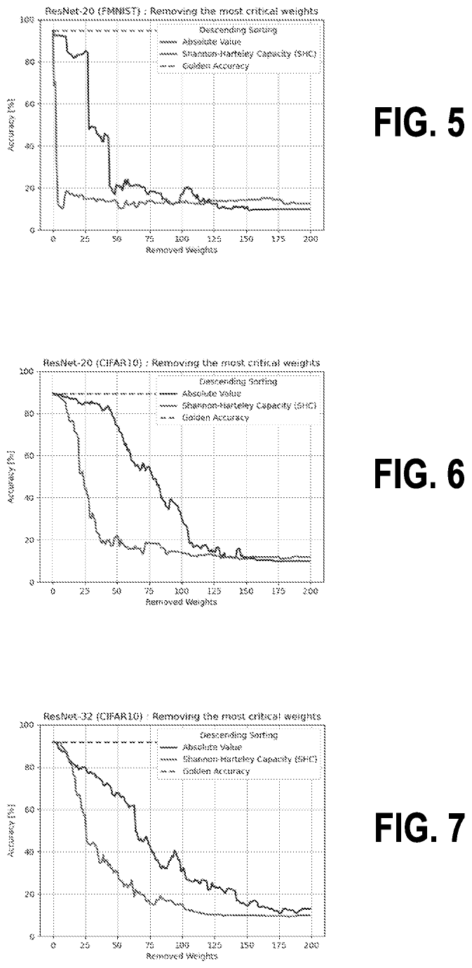

FIG. 5 is an experimentation result illustrating the evolution of the accuracy of a ResNet-20 CNN trained and tested on FMNIST, as a function of a number of removed weights.

In that case, ResNet-20 is trained and tested on the FMNIST dataset. To experimentally demonstrate that a high SHC metric corresponds to a high criticality, all the weights of the CNN were ordered in descending order according to their SHC value. Then, starting from the weight having the highest SHC, the given weight was removed (putting it at zero) and the inferences of the entire test set were executed (10,000 FMNIST images). Then the final accuracy of the CNN was computed.

The same experiment was performed with the second weight (in the same order), without restoring the previous one (so, in a cumulative way), and the accuracy was measured. And the process was iteratively repeated by following the descending order of the weights.

The plot in grey of FIG. 5 illustrates the evolution of accuracy as a function of a number of removed weights, when processing weights of the CNN in descending order.

The same experiment was then performed by ordering weights according to the absolute value of the weight itself. The plot in black of FIG. 5 shows that, by removing one single weight (the one with the highest SHC), the accuracy of the CNN drops from the golden value 94.86% to 68.69%. To obtain the same accuracy decrease (about 26%), it must be removed 28 weights presenting the highest absolute values. Additionally, by removing only 5 weights with the highest SHC, the studied CNN becomes a random classifier. From the safety and reliability point of view, this assumes great relevance, as it can be concluded that, with the removal of only 5 weights, the model becomes functionally useless.

Table 2 illustrates the number of weights that, in both cases (absolute values or SHC metric), should be removed to obtain a specific drop in accuracy, when using the FMNIST dataset.

TABLE 2
number of weights to remove to obtain a specific
drop in the accuracy of ResNet-20 (FMNIST).
ResNet-20 (FMNIST)

| | | | Percentage |
|---|---|---|---|
| | | | variation [%] |
| | Number of weights | | between |
| | removed from the computation | | absolute |
| Drop in | Ordered based | Ordered based | value- and |
| Accuracy | on their | on the | SHC-based |
| [%] | absolute value | SHC metric | removal |
| 2 | 10 | 1 | −90.00 |
| 5 | 11 | 1 | −90.91 |
| 10 | 12 | 1 | −91.67 |
| 20 | 28 | 1 | −96.43 |
| 50 | 38 | 3 | −92.11 |
| 70 | 44 | 4 | −90.91 |
| 80 | 85 | 5 | −94.12 |

FIG. 6 is an experimentation result illustrating the evolution of the accuracy of a ResNet-20 CNN trained and tested on CIFAR10, as a function of a number of removed weights.

In that case, ResNet-20 is trained and tested on the CIFAR10 dataset. Table 3 show the number of weights that, in both cases, should be removed to obtain a specific drop in accuracy.

TABLE 3
number of weights to remove to obtain a specific
drop in the accuracy of ResNet-20 (CIFAR10)
ResNet-20 (CIFAR10)

| | | | Percentage |
|---|---|---|---|
| | | | variation [%] |
| | Number of weights | | between |
| | removed from the computation | | absolute |
| Drop in | Ordered based | Ordered based | value- and |
| Accuracy | on their | on the | SHC-based |
| [%] | absolute value | SHC metric | removal |
| 2 | 3 | 1 | −66.67 |
| 5 | 20 | 10 | −50.00 |
| 10 | 46 | 12 | −73.91 |
| 20 | 54 | 18 | −66.67 |
| 50 | 84 | 28 | −66.67 |
| 70 | 106 | 37 | −65.09 |
| 80 | 157 | 130 | −17.20 |

To reduce the final accuracy of the ResNet-20 model by 2%, only 1 weight selected according to the SHC metric is enough. To obtain the same accuracy drop, we need to remove the 3 weights having the highest absolute value.

The difference is non-negligible. As shown in FIG. 6, by removing the 50 weights having the highest SHC value, the accuracy drops below the 20% of correct predictions. Removing the same quantity (50 weights) according to the absolute value, the accuracy keeps greater than 70%: a percentage variation of −72.5%.

FIG. 7 is an experimentation result illustrating the evolution of the accuracy of a ResNet-32 CNN trained and tested on CIFAR10, as a function of a number of removed weights.

ResNet-32 is trained and tested on the CIFAR10 dataset and reaches a golden accuracy equal to 93.09%. The experimental results, shown in FIG. 7 and Table 4 illustrate that, despite an initial negligible opposite trend, ordering weights according to the SHC value enables the identification of the most critical weights for the CNN.

TABLE 4
Number of weights to remove to obtain a specific
drop in the accuracy of ResNet-32 (CIFAR10)
ResNet-32 (CIFAR10)

| | | | Percentage |
|---|---|---|---|
| | | | variation |
| | | | [%] |
| | Number of weights removed | | between |
| | from the computation | | absolute |
| Drop in | Ordered based | Ordered based | value- and |
| Accuracy | on their | on the | SHC-based |
| [%] | absolute value | SHC metric | removal |
| 2 | 4 | 5 | 25.00 |
| 5 | 7 | 9 | 28.57 |
| 10 | 12 | 12 | 0 |
| 20 | 39 | 18 | −53.85 |
| 50 | 74 | 27 | −63.51 |
| 70 | 130 | 62 | −52.31 |
| 80 | 159 | 102 | −35.85 |

### Effects of the SHC on the CNN Model Compression and Optimization

This invention shows that the assignment of the proposed Shannon-Hartley Criticality to individual weights identifies the most important parameters of the convolutional neural network. This may be advantageous for two reasons: for identifying the most critical weights, and for selecting the least critical ones. This last category represents the set of the least significant weights of a CNN that can be safely removed, i.e., pruned, without reducing the accuracy of the CNN. Compared to state-of-the-art approaches, a greater quantity of weights ordered based on the SHC metric can be removed without affecting the accuracy of the CNN. This means that the memory footprint of the CNN application is reduced, as well as the power consumption related to the missing operations that the removed weight involves.

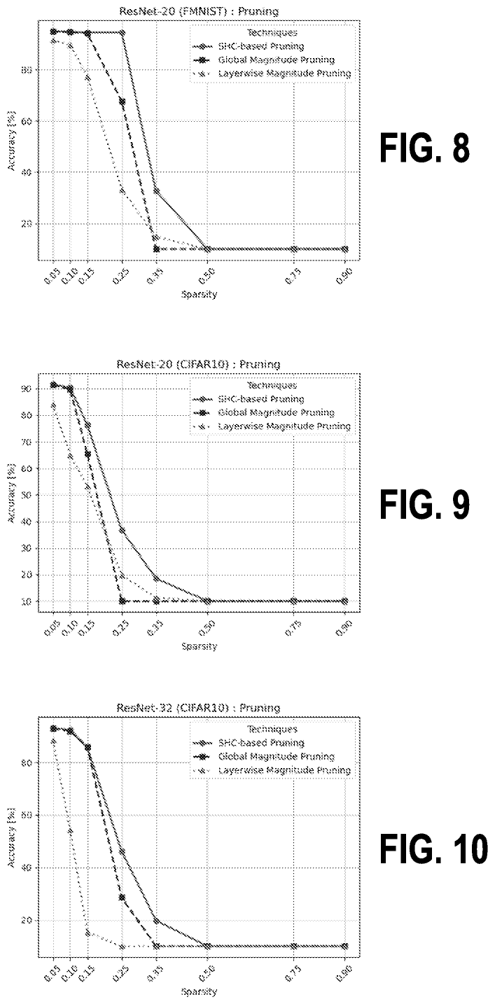

In the following experiments illustrated by FIGS. 8, 9 and 10, the effect of the removal of the least significant weights (those having the smaller SHC) is assessed in terms of accuracy of the CNN model. Specifically, for a specific sparsity, the accuracy of the CNN model is measured.

Sparsity can be defined as the ratio of the number of parameters in the original network to the number of parameters that were pruned. Less non-zero parameters are present in the pruned networks as sparsity increases.

$$s = ( 1 - \frac{\vert {W}^{′} \vert}{\vert W \vert} )$$

The sparsity is obtained by pruning weights according to the proposed Shannon-Hartley Criticality measure (“SHC-based pruning”) and the state-of-the-art pruning approaches based on the weight magnitude criteria, which state that the superfluous weights are expected to be those of lesser magnitude.

### SHC-Based Pruning

The weights having the lowest SHC measure are pruned for a specific sparsity measure. It belongs to the category of static and unstructured pruning approach. In a static pruning approach, the optimization is performed offline after training and before inference. Well-known methods of pruning commonly have three steps: 1) a selection of parameters to prune 2) an application of the pruning of elements (weights or neurons typically), and the 3) an optional re-training or fine-tuning. The proposed SHC-based pruning does not involve any re-training or fine-tuning phase. Retraining the pruned network has the potential to enhance its performance, leading to accuracy like that of the unpruned network. However, this process may necessitate substantial offline computation time and energy. Unstructured pruning methods remove insignificant parameters based on heuristics but retain the original structure.

The proposed SHC-based static pruning is then compared with two state-of-the-art widely used and well-known approaches, the Global Magnitude pruning (L₁-norm), and the Layer-wise Magnitude pruning (L₁-norm).

The Global Magnitude pruning (L₁-norm) is a state-of-the-art pruning technique that consists in removing a defined quantity of weights form the entire CNN model. CNNs are pruned by removing the specified amount of (currently unpruned) units with the lowest L1-norm, i.e., absolute value. It is widely accepted that training weights with large values are more important than trained weights with smaller values (Wang Lei, H. C. (2017)). Even though sophisticated methods have been proposed in the last few years, such as the Hessian pruning (the second derivative of the loss function), the complexity of today's DNNs does not allow for these offline computations. As an example, GPT-3 (Tom B. Brown, B. M.-V. (2020)) contains 175-billion parameters: calculating the Hessian matrix during training for networks with the complexity of GPT-3 is not currently feasible (Tailin Liang, J. G. (2021)). For this reason, this invention compares the performance of the SHC-based static pruning with simpler magnitude-based pruning based only on the element-wise contribution of the weights, simple but still effective pruning techniques.

The Layer-wise Magnitude pruning (L₁-norm) is a state-of-the-art pruning technique that consists in removing the same quantity of weights from every layer of the CNN. CNNs are pruned by removing the specified amount of (currently unpruned) units with the lowest L1-norm from a specific layer, for a specific sparsity. In other words, this pruning method applies the same rate to each layer, while global magnitude pruning applies it on the whole neural network at once.

As shown in FIGS. 8 to 10, the higher the sparsity (x-axis), the higher the quantity of removed weights, the worse the accuracy of the CNN under analysis. The y-axis reports the accuracy that the CNN yields after the removal of a set of weights (indicated by the sparsity value). It is worth noting that in these experimental evaluations, the pruning approaches do not include any retraining of the CNN model. The accuracy is measured by running the inferences of the entire training set, during the inference phase, after the removal of the weights.

Table 5 reports the memory footprint reduction that each different pruning technique leads for a specific acceptable drop in accuracy. In other words, with a 1% reduction in accuracy, the proposed SHC metric allows to save about 18% of memory occupation, compared to about 15% of the global magnitude pruning (the state-of-the-art approach). This is in evident contrast with the layer-wise magnitude pruning, where the drop is obtained with the removal of only 2 weights (the 7.3*10⁻⁴ of the total). It is worth highlighting that, better results for the SHC-based pruning are obtained with a greater drop, but, at that point, the neural network is no more functionally usable.

TABLE 5
Memory footprint reduction for a specific
drop in accuracy: ResNet-20 (FMNIST)

Memory

| footprint | Drop in accuracy (%) | | | |
|---|---|---|---|---|
| reduction (%) | 1 | 2 | 5 | 10 |
| SHC-based | −18.23 | −19.89 | −23.03 | −24.50 |
| Pruning | | | | |
| Global | −15.85 | −17.87 | −19.35 | −20.45 |
| Magnitude | | | | |
| Pruning | | | | |
| Layer-wise | 7.3*10⁻⁴ | 1.1*10⁻³ | 1.4*10⁻³ | 1.8*10⁻³ |
| Magnitude | | | | |
| Pruning | | | | |

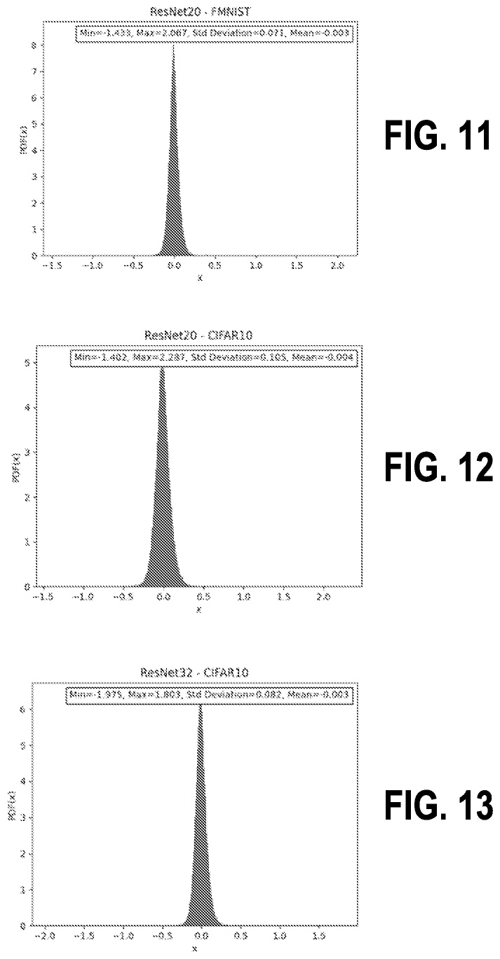

This can be observed in FIG. 9. The same trend for other networks is obtained, as shown in FIGS. 10 and 11, and reported in Tables 6 and 7.

TABLE 6
Memory footprint reduction for a specific
drop in accuracy: ResNet-20 (CIFAR-10)

Memory

| footprint | Drop in accuracy (%) | | | |
|---|---|---|---|---|
| reduction (%) | 1 | 2 | 5 | 10 |
| SHC-based | 9.54 | 10.27 | 13.68 | 13.68 |
| Pruning | | | | |
| Global | 7.67 | 9.65 | 10.86 | 12.33 |
| Magnitude | | | | |
| Pruning | | | | |
| Layer-wise | 3.7*10⁻⁴ | 3.7*10⁻⁴ | 1.1*10⁻³ | 1.1*10⁻³ |
| Magnitude | | | | |
| Pruning | | | | |

TABLE 1
Memory footprint reduction for a specific
drop in accuracy: ResNet-32 (CIFAR-10)

Memory

| footprint | Drop in accuracy (%) | | | |
|---|---|---|---|---|
| reduction (%) | 1 | 2 | 5 | 10 |
| SHC-based | 10.95 | 11.81 | 12.67 | 14.81 |
| Pruning | | | | |
| Global | 8.58 | 10.52 | 12.45 | 17.17 |
| Magnitude | | | | |
| Pruning | | | | |
| Layer-wise | 2.1*10⁻⁴ | 4.2*10⁻⁴ | 6.4*10⁻³ | 6.4*10⁻³ |
| Magnitude | | | | |
| Pruning | | | | |

### Discussion of the Results and the Applicability of the SHC Measure Depending on the Probability Density Function (PDF) of the CNN Under Investigation.

FIGS. 11 to 13 illustrate the probability density function of different CNNs trained and tested on FMNIST and CIFAR10 datasets.

The effectiveness of the invention is related to the quality of the CNN in terms of proportion of the architectural model to the dataset. The more the CNN is over-parametrized or over-provisioned, the less the SHC measure is effective. Over-parametrized means that the CNN architecture is furnished with more synaptic weights or artificial neurons with respect to the minimal number required to perform the computation. As shown in the experimental results, a ResNet-20 architecture already fits the required CIFAR10 dataset. Indeed, the SHC metric provides better results compared to the ResNet-32 architecture trained and tested on the same dataset (CIFAR10).

Up to now, results and performance of the invention have been mainly described by considering classification as an example of use of the compressed neural network. However, the accuracy of that compression method was also tested for others tasks, such as image recognition. A ResNet-32 neural network trained with the CIFAR10 dataset was considered, and an accuracy of 93.09% was reached.

During that experimentation, the network weights were sorted in terms of criticality, i.e., what were the weights impacting the most on the CNN accuracy. Based on that ordered list of weights, a certain amount of network parameters (or weights) was removed accordingly to a predetermined threshold given in terms of accuracy drop.

Table 8 shows the percentage of weights removed, as a function of an accuracy value. It is worth noting that a reduction of 10.95% of the network weights has a significant reduction of about 47.000 parameters at the cost of only 1% of accuracy drop (1% column).

Drop in accuracy [%]

| | −1% | −2% | −5% | −10% |
|---|---|---|---|---|
| % of removed | 10.95 | 11.81 | 12.67 | 14.81 |
| synaptic | | | | |
| weights | | | | |
| Accuracy | 92.09% | 91.09% | 88.09% | 83.09% |

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs, that is, one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal, for example, a machine-generated electrical, optical, or electromagnetic signal that is generated to encode information for transmission to a receiver apparatus for execution by a data processing apparatus. The computer-storage medium can be a machine-readable storage device, a machine-readable storage substrate, a random or serial access memory device, or a combination of computer-storage mediums. Configuring one or more computers means that the one or more computers have installed hardware, firmware, or software (or combinations of hardware, firmware, and software) so that when the software is executed by the one or more computers, particular computing operations are performed.

A computer program, which can also be referred to or described as a program, software, a software application, a unit, a module, a software module, a script, code, or other component can be written in any form of programming language, including compiled or interpreted languages, or declarative or procedural languages, and it can be deployed in any form, including, for example, as a stand-alone program, module, component, or subroutine, for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub-programs, or portions of code. A computer program can be deployed to be executed on one computer or on multiple computers that are located at one site or distributed across multiple sites and interconnected by a communication network.

While portions of the programs illustrated in the various figures can be illustrated as individual components, such as units or modules, that implement described features and functionality using various objects, methods, or other processes, the programs can instead include a number of sub-units, sub-modules, third-party services, components, libraries, and other components, as appropriate. Conversely, the features and functionality of various components can be combined into single components, as appropriate. Thresholds used to make computational determinations can be statically, dynamically, or both statically and dynamically determined.

Described methods, processes, or logic flows represent one or more examples of functionality consistent with the present disclosure and are not intended to limit the disclosure to the described or illustrated implementations, but to be accorded the widest scope consistent with described principles and features. The described methods, processes, or logic flows can be performed by one or more programmable computers executing one or more computer programs to perform functions by operating on input data and generating output data. The methods, processes, or logic flows can also be performed by, and apparatus can also be implemented as, special purpose logic circuitry, for example, a CPU, an FPGA, or an ASIC.

Non-transitory computer-readable media for storing computer program instructions and data can include all forms of media and memory devices, magnetic devices, magneto optical disks, and optical memory device. Memory devices include semiconductor memory devices, for example, random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. The processor and the memory can be supplemented by, or incorporated in, special purpose logic circuitry.

While this specification contains many specific implementation details, these should not be construed as limitations on the scope of what can be claimed, but rather as descriptions of features that can be specific to particular implementations. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features can be described as acting in certain combinations and even initially claimed as such, one or more features from a claimed combination can, in some cases, be excised from the combination, and the claimed combination can be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations can be considered optional), to achieve desirable results. In certain circumstances, multitasking or parallel processing (or a combination of multitasking and parallel processing) can be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

### Domains and Applications

This invention significantly enhances performance, efficiency, and security in diverse artificial intelligence applications using CNNs, particularly in processing and analysing spatially structured data.

Here is an overview regarding different applications or markets concerned:
Semiconductor industry: With Artificial Intelligence (AI) processing demands accelerating, the semiconductor market's growth is projected to continue. This invention's ability to optimize CNNs directly contributes to reducing computational loads, making semiconductor components more efficient and capable of handling advanced AI tasks.
Image recognition systems. Emphasizing the widespread adoption of image analysis solutions across health, e-commerce, and more, the invention's precision in identifying crucial network parameters enhances image recognition accuracy, vital for applications ranging from medical diagnostics to customer engagement in e-commerce.
Robotics and industrial automation: the industrial robotics market grow indicates the expanding role of intelligent automation and the need for advanced vision capabilities in complex environments. By refining CNN performance, the invention elevates robots' visual processing capabilities, enabling more sophisticated and autonomous decision-making in automation.
Public safety and video analysis: this market underscores the critical need for sophisticated surveillance and real-time analytical technologies. Enhancements in CNN efficiency and security are crucial for real-time video analysis, improving public safety through faster and more accurate detection.
Environmental diagnostics and climate change monitoring: investments in these areas are increasing, with significant allocations towards technology and innovation for climate action, highlighting the urgency and market potential for advanced analytical solutions. This technology plays a key role in processing environmental data, aiding in the accurate monitoring and prediction of climate change impacts.
Online education and training: optimization of CNNs enhances the capability of AI to provide tailored educational content, making online learning more engaging and effective.
Language models and generative AI: if applied to image analysis or other forms of spatially structured data, this invention allows the development of more nuanced and contextually aware language models and generative AI, pivotal for creating content that more accurately reflects human knowledge and creativity.
Precision agriculture: the invention supports the analysis of complex agricultural data, optimizing resource use and crop health monitoring through advanced imaging technologies.

Entertainment and content creation: the digital entertainment sector, including AI-driven content creation, is rapidly expanding. Improvements in CNN performance foster the generation of high-quality, creative content, transforming how stories are told and experiences are crafted in the digital realm.

While this enumeration highlights a broad spectrum of application markets, it is by no means exhaustive. This list serves to illustrate the wide array of applications that can potentially benefit from this invention, underscoring its versatility and transformative potential across numerous domains.

### REFERENCES

Wang Lei, H. C. (2017). Compressing Deep Convolutional Networks Using K-means Based on Weights Distribution. Proceedings of the 2nd International Conference on Intelligent Information Processing (p. 10). Bangkok, Thailand: ACM.
Tom B. Brown, B. M.-V. (2020). Language models are few-shot learners. NIPS'20: Proceedings of the 34th International Conference on Neural Information Processing Systems, 1877-1901.
Tailin Liang, J. G. (2021). Pruning and quantization for deep neural network acceleration: A survey. Neurocomputing, 307-403.

1. A computer-implemented method for compressing a neural network comprising neurons and synapses interconnecting the neurons, the method being implemented by a compressing device and comprising:
determining, for each synapse of a plurality of synapses of the neural network, a capacity representative of a level of influence of a synaptic weight assigned to the synapse, the capacity being determined as a function of the synaptic weight and as a function of data exchanged through the synapse; and
pruning one or more synapses of the plurality of synapses, as a function of the determined capacity of each of the one or more synapses.

2. The method of claim 1, wherein the one or more pruned synapses have a determined capacity lower than or equal to a first threshold.

3. The method of claim 1, wherein pruning one or more synapses comprises removing the one or more synapses from the neural network, or setting the synaptic weights assigned to the one or more synapses to zero, or removing the synaptic weight assigned to the one or more synapses from a set of parameters of the neural network.

4. The method of claim 1, wherein the capacity Cₛ_{ⱼ} of a synapse sⱼ is determined as a function of
$$\vert {w}_{k} \vert * {log}_{2} ( 1 + \frac{{i}_{j}}{\frac{\partial L}{\partial {w}_{k}}} )$$
where
$$\frac{\partial L}{\partial {w}_{k}}$$
is the partial derivative of a loss L with respect to a synaptic weight wₖ, and iⱼ is a parameter representative of the data exchanged through the synapse.

5. The method of claim 1, wherein a comparable synaptic weight is assigned to a plurality of synapses, the method further comprising determining a criticality of the comparable synaptic weight as a function of the determined capacities of the plurality of synapses assigned with a comparable synaptic weight;
and the pruning comprises pruning the plurality of synapses assigned with the comparable synaptic weight, if the determined criticality is than or equal to a second threshold.

6. The method of claim 5, wherein the criticality of the comparable synaptic weight is determined by adding the capacities of the synapses of the plurality assigned with a comparable synaptic weight.

7. The method of claim 5, wherein the synapses of the plurality of synapses are assigned with a comparable synaptic weight if the synapses are assigned with a same synaptic weight or if the synapses are assigned with a synaptic weight belonging to a predetermined range.

8. The method of claim 5, wherein the criticality C_{w}_{ₖ} of the comparable synaptic weight wₖ is determined as a function of
$${\sum }_{j = 0}^{J - 1} ( \vert {w}_{k} \vert * {log}_{2} ( 1 + \frac{{i}_{j}}{\frac{\partial L}{\partial {w}_{k}}} ) )$$
with wₖ the synaptic weight
$$\frac{\partial L}{\partial {w}_{k}}$$
the partial derivative of a loss L with respect to the synaptic weight wₖ, iⱼ a parameter representative of the data exchanged through a synapse j∈[0,J−1], and J the number of synapses assigned with a comparable synaptic weight.

9. The method of claim 1, wherein the neural network is an over-parameterized convolutional neural network.

10. A non-transitory computer-readable recording medium on which a computer program is recorded comprising instructions which when executed by a processor of a compressing device configure the compressing device to implement a method for compressing a neural network comprising neurons and synapses interconnecting the neurons, the method comprising:
determining, for each synapse of a plurality of synapses of the neural network, a capacity representative of a level of influence of a synaptic weight assigned to the synapse, the capacity being determined as a function of the synaptic weight and as a function of data exchanged through the synapse; and
pruning one or more synapses of the plurality of synapses, as a function of the determined capacity of each of the one or more synapses.

11. A compressing device including:
at least one processor; and
at least one non-transitory computer readable medium comprising instructions stored thereon which when executed by the at least one processor configure the compressing device to:
determine, for each synapse of a plurality of synapses of the neural network, a capacity representative of a level of influence of a synaptic weight assigned to the synapse, the capacity being determined as a function of the synaptic weight and as a function of data exchanged through the synapse; and
prune one or more synapses of the plurality of synapses, as a function of the determined capacity of each of the one or more synapses.
